(19) United States
(12) Patent Application Publication
(10) Pub. No.: US 2005/0088516 A1
(43) Pub. Date: Apr. 28, 2005

(54) Display device for both two-dimensional and three-dimensional images and display method thereof

(76) Inventors: Myoung-Seop Song, Suwon-si (KR); Jang-Doo Lee, Suwon-si (KR); Hyoung-Wook Jang, Suwon-si (KR); Hui Nam, Suwon-si (KR); Beom-Shik Kim, Suwon-si (KR)

Correspondence Address: CHRISTIE, PARKER & HALE, LLP, PO BOX 7068, PASADENA, CA, 91109-7068, US

(21) Appl. No.: 10/923,513

(22) Filed: Aug. 20, 2004

(30) Foreign Application Priority Data
Oct. 23, 2003 (KR) 2003-0074225
Mar. 10, 2004 (KR) 2004-0016143

(51) Int. Cl. H04N 13/00

(52) U.S. Cl. 348/51; 348/42

(57) ABSTRACT

A stereoscopic display device determines whether an input image is a two-dimensional (2D) or three-dimensional (3D) image, and converts the resolution of a display panel based on determination results. When the input image is displayed by execution of a specific program, the start signal, the end signal, or the inactivation signal of the specific program is detected. With the start signal of the program detected, the stereoscopic display device determines whether the program is a 2D or 3D program. With the end signal or the inactivation signal of the program detected, the stereoscopic display device determines whether the image to be displayed on the display panel is a 2D or 3D image. The display device converts the resolution of the display panel according to the determination results.

### CROSS REFERENCE TO RELATED APPLICATION

This application claims priority to and the benefit of Korea Patent Application Nos. 2003-74225 filed on Oct. 23, 2003; and 2004-16143 filed on Mar. 10, 2004, both filed in the Korean Intellectual Property Office, the entire contents of which are incorporated herein by reference.

### BACKGROUND OF THE INVENTION

(a) Field of the Invention

The present invention relates to an image display device and a display method thereof. More specifically, the present invention relates to a stereoscopic display device for displaying both two-dimensional (2D) and three-dimensional (3D) images, and a display method thereof.

(b) Description of the Related Art

There are two types of display devices that are generally used for displaying 3D images. One is a stereoscopic display device using the barrier method, and the other is a stereoscopic display device using a lenticular lens.

FIG. 1 shows a part of the stereoscopic display device using the barrier method that employs a liquid crystal (LC) shutter for presenting left and right eye images separately to give a stereo visual effect. The stereo display device shown in FIG. 1 is disclosed in U.S. Pat. No. 5,969,850, in which the display device comprises first substrate 11, second substrate 12, a liquid crystal layer 14 and column electrodes 15, 16. The stereo display device controls the on/off switch of the LC shutter by applying or cutting off power to the column electrodes 15, 16 for 2D-3D image display conversion. However, the use of the LC shutter requires the use of an additional driver circuit to control the on/off switch of the LC shutter.

FIG. 2 shows a stereoscopic display device using a lenticular lens that divides pixels into sub-pixels to present left and right eye images separately. The stereoscopic display device shown in FIG. 2 is disclosed in U.S. Pat. No. 5,500,765, in which the display device includes first lens sheet 26 and second lens sheet 28. First lens sheet 26 is fixedly mounted in the display screen for auto-stereoscopic imaging of the two-dimensional screen images and second lens sheet 28 is selectively engageable with first lens sheet 26 to convert the display to a 2D viewing mode.

FIG. 3a shows the principle of the stereo visual effect of the stereoscopic display device using the barrier method as shown in FIG. 1, and FIG. 3b shows the principle of the stereo visual effect of the stereoscopic display device using a lenticular lens as shown in FIG. 2.

As illustrated in FIGS. 3a and 3b, the display device using the barrier method or a lenticular lens spatially divides the image into left and right eye images to give a stereo visual effect, so its display panel is required to have a higher resolution than the display panel of a 2D display device. For example, when an n-view stereoscopic display device displays a 2D image, the actual screen is divided into n spaces so as to display a composite image combining left and right eye images, thereby reducing the resolution of the displayed image to 1/n.

When the display device using the barrier method or a lenticular lens displays a 2D image instead of a 3D image, the image is displayed on the display panel of a higher resolution rather than with just an adequate resolution, so image distortion occurs that makes it difficult to discriminate characters or icons displayed.

For this reason, the display device using the barrier method or a lenticular lens is not widely used as a general-purpose display device, but is only used for a 3D display.

### SUMMARY OF THE INVENTION

In accordance with the present invention a stereoscopic display device is provided that is capable of displaying both 2D and 3D images by converting the resolution of a display panel.

Further in accordance with the present invention a display device is provided that properly converts the resolution of the display panel according to the type of an input image.

Still further in accordance with the present invention a stereoscopic display device is provided that is capable of displaying both 2D and 3D images by converting an input image signal based on the resolution of the display panel used for a 3D display.

Yet further in accordance with the present invention a display device is provided that properly converts an input image signal based on the resolution of the display panel.

Further in accordance with the present invention an executable program on a recording medium is provided that has a function of properly converting the resolution of the display panel according to the type of an input image.

In one aspect of the present invention, there is provided a stereoscopic display device that includes: an image discriminator for determining whether the input image is a 2D image or a 3D image; and a resolution converter for converting a resolution of the display panel based on the determination result of the image discriminator.

The input image can be displayed by an execution of instructions for a specific program. In this case, the stereoscopic display device further includes a signal detector for detecting a start signal, an end signal, or an inactivation signal of the specific program, and outputting the detected signal to the image discriminator.

With the start signal of the program detected by the signal detector, the image discriminator determines whether the program is a 2D program or a 3D program. With the end signal or the inactivation signal of the program detected by the signal detector, the image discriminator determines whether an image to be displayed on the display panel is a 2D image or a 3D image.

In another aspect of the present invention, there is provided a stereoscopic display method that includes: (a) determining whether an input image is a 2D image or a 3D image; (b) converting the resolution of a display panel based on the determination result of the step (a); and (c) displaying the input image on the display panel.

In another further aspect of the present invention, there is provided a stereoscopic display device that includes: an image discriminator for determining whether the input image is a 2D image or a 3D image; and an image signal converter for converting a resolution of the input image according to a resolution of the display panel based on the determination result of the image discriminator.

The display panel has a resolution for displaying a 3D image. When the input image is a 2D image, the image signal converter converts the resolution of the input image based on the resolution of the display panel.

Alternatively, the display panel has a resolution for displaying a 2D image. When the input image is a 3D image, the image signal converter converts the resolution of the input image based on the resolution of the display panel.

In still another aspect of the present invention, there is provided a stereoscopic display method that includes: (a) determining whether an input image is a 2D image or a 3D image; and (b) converting a resolution of the input image based on the resolution of a display panel according to the determination result of the step (a).

### BRIEF DESCRIPTION OF THE DRAWINGS

FIG. 1 is a partial diagram of a stereoscopic display device using a barrier method.

FIG. 2 is a diagram of a stereoscopic display device using a lenticular lens.

FIG. 3a shows the principle of the stereo visual effect of the stereoscopic display device using a barrier method.

FIG. 3b shows the principle of the stereo visual effect of the stereoscopic display device using a lenticular lens.

FIG. 4 is a schematic block diagram of a display device according to a first embodiment of the present invention.

FIG. 5 is a schematic block diagram of a display device according to a second embodiment of the present invention.

FIG. 6 is a flow chart of a display method for the display device according to the second embodiment of the present invention.

FIG. 7 is a schematic block diagram of a display device according to a third embodiment of the present invention.

FIG. 8 shows an example in which 2D and 3D images are displayed on the display panel according to the third embodiment of the present invention.

FIG. 9 is a flow chart of a display method for the display device according to the third embodiment of the present invention.

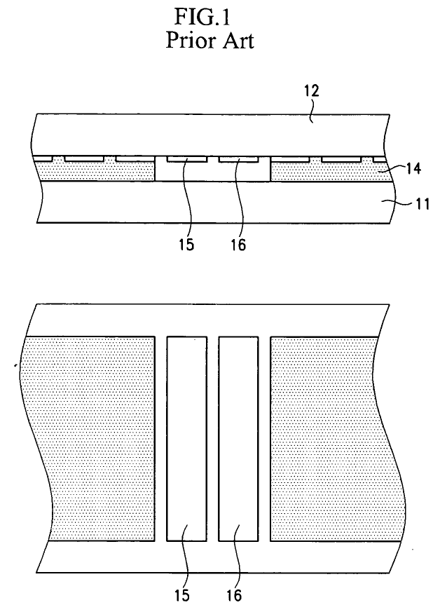

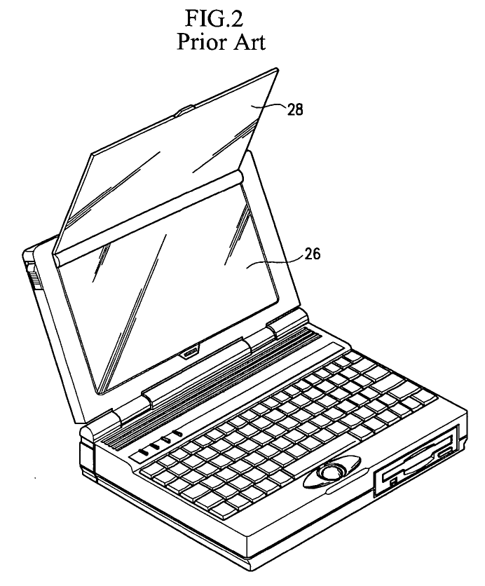

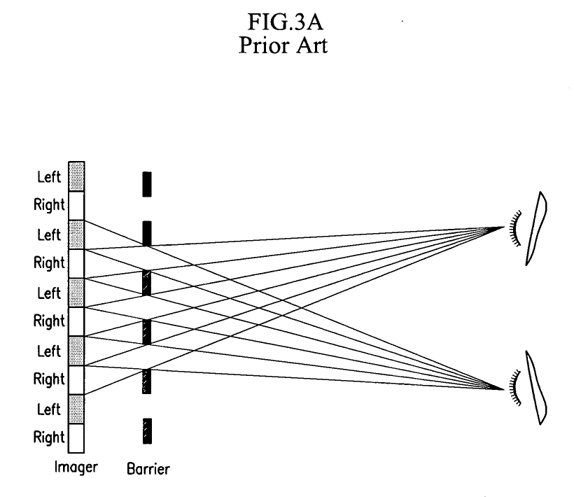

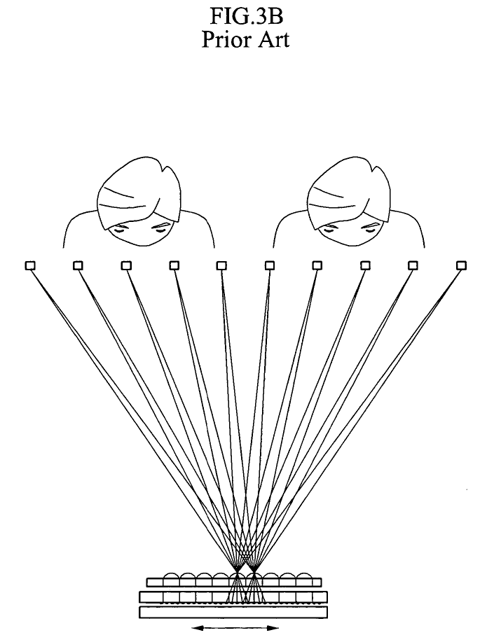

### DETAILED DESCRIPTION

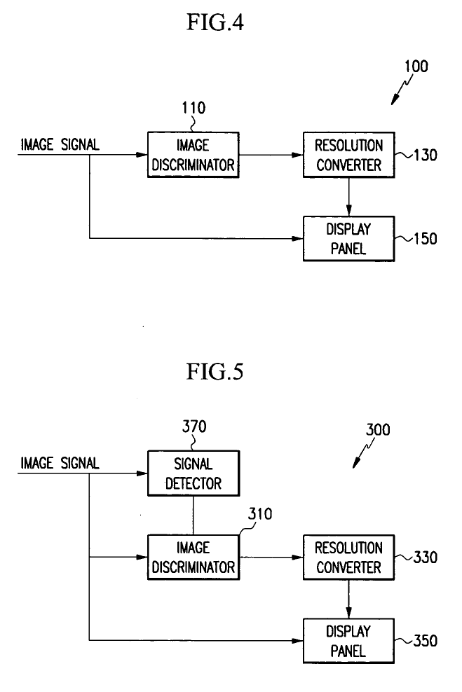

Referring to FIG. 4, display device 100 includes image discriminator 110, resolution converter 130, and display panel 150.

Image discriminator 110 determines whether input image data are to be displayed as a 3D image or a 2D image. Based on the determination result, image discriminator 110 determines a resolution mode and outputs it to resolution converter 130.

Resolution converter 130 converts the resolution mode of display panel 150. More specifically, resolution converter 130 receives the determined resolution mode from image discriminator 110, and determines whether or not the input resolution mode is the same as the current resolution mode of display panel 150. If the input resolution mode is the same as the current resolution mode of display panel 150, then resolution converter 130 does not convert the resolution. Otherwise, if the input resolution mode is not the same as the current resolution mode, then resolution converter 130 converts the resolution of the display panel into the resolution mode determined by image discriminator 110.

If the input image data represent a 3D image and the current resolution mode is 2D, then resolution converter 130 converts the resolution mode of display panel 150 into the 3D mode. If the input image data represent a 3D image and the current resolution mode is 3D, then resolution converter 130 maintains the current resolution mode.

By this conversion operation of resolution converter 130 to convert the resolution mode, display device 100 can display the input image data on display panel 150 without distortion.

FIG. 5 is a schematic of a display device according to a second embodiment of the present invention. Display device 300 includes image discriminator 310, resolution converter 330, display panel 350, and signal detector 370 for detecting program starVend/inactivation signals.

Signal detector 370 detects the start, end, and inactivation signals for a specific program when an image of the same type (2D or 3D) is displayed on display panel 350 while the corresponding program is executed. Upon detection of the start signal, signal detector 370 sends a control signal to image discriminator 310 to determine the type of the image to be displayed during the execution of the program started.

Image discriminator 310 determines whether the image to be displayed during the execution of the specific program is a 2D image or a 3D image, i.e., whether the program executed is a 2D program or a 3D program. Based on the determination result, image discriminator 310 determines the resolution mode and outputs it to resolution converter 330. Alternatively, when the program being executed is terminated or inactivated, image discriminator 310 checks the image type of the program to be activated, determines the resolution mode corresponding to the image type of the program, and outputs it to resolution converter 330.

Resolution converter 330 converts the resolution mode of the display panel. More specifically, resolution converter 330 determines whether or not the input resolution mode based on the determination result of image discriminator 310 is the same as the current resolution mode of display panel 350, so as to convert or maintain the current resolution mode. If the input resolution mode is the same as the current resolution mode of display panel 350, then resolution converter 330 does not convert the resolution. Otherwise, if the input resolution mode is not the same as the current resolution mode, then resolution converter 330 converts the resolution of display panel 350 into the resolution mode determined by image discriminator 310.

If a specific program is a 3D program and the current resolution mode of display panel 350 is 2D, then resolution converter 330 converts the resolution mode of display panel 350 into the 3D mode. If the specific program is a 3D program and the current resolution mode of display panel 350 is 3D, then resolution converter 330 maintains the current resolution mode.

By this conversion operation of resolution converter 330 for the conversion of the resolution mode, the display device can display the executed program on display panel 350 without distortion.

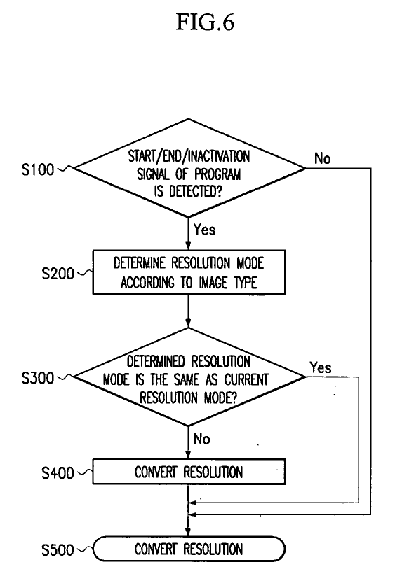

FIG. 6 is a flow chart of a display method for the display device according to the second embodiment of the present invention.

First, signal detector 370 detects program start/end/inactivation signals, in step S100.

Without any program start/end/inactivation signal detected, the display device continues to display the image on display panel 350 without a step of converting the resolution mode, in step S500.

With a program start/end/inactive signal detected, image discriminator 310 determines whether the program to be displayed on display panel 350 is a 2D program or a 3D program, and determines the corresponding resolution mode, in step S200.

Resolution converter 330 determines in step S300 whether or not the resolution mode determined by image discriminator 310 is the same as the current resolution mode.

If the determined resolution mode is not the same as the current resolution mode, then resolution converter 330 converts the resolution of display panel 350 into the resolution mode determined in step S200, in step S400, and the image is displayed on display panel 350, in step S500.

If the determined resolution mode is the same as the current resolution mode, then the image is displayed on display panel 350 without conversion of the resolution.

The image signal display method can be executed with the display device including image discriminator 310, resolution converter 330, and signal detector 370.

The display method implemented by the display device guarantees a stable and rapid conversion of resolution.

The display method can also be realized with a recording medium storing software programmed to execute instructions pertaining to respective steps S100 to S500, instead of adding the component modules to the display device. This recording medium includes electronic recording media, such as a floppy disk, hard disk, CD-ROM, etc.

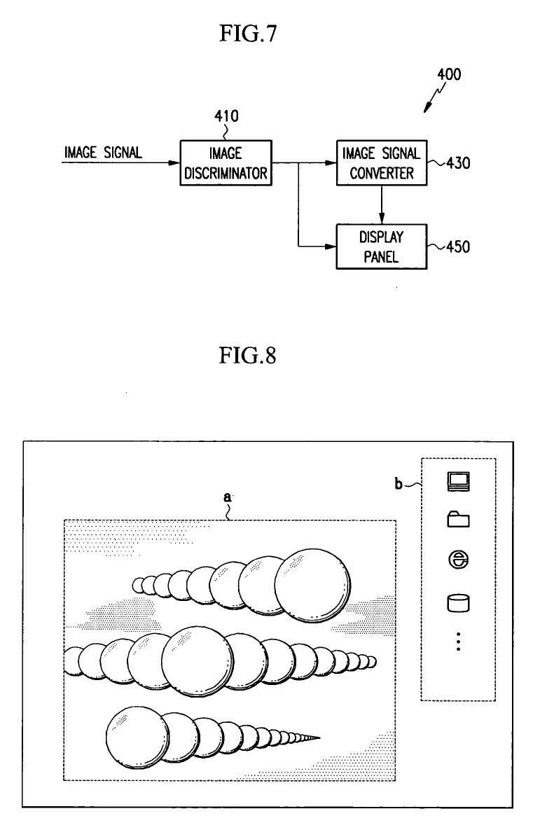

FIG. 7 is a schematic of display device 400 according to a third embodiment of the present invention. Display device 400 includes image discriminator 410, image signal converter 430, and panel 450. Display device 400 according to this embodiment is a stereoscopic display device that displays a stereoscopic image on display panel 450. Image discriminator 410 determines whether input image data represent a 2D image or a 3D image. If the input image data represent a 2D image, then image discriminator 410 informs image signal converter 430 that the input image data represent a 2D image. Upon receiving the 2D image from image discriminator 410, image signal converter 430 converts the resolution of the input image data based on the resolution of display panel 450 so as to display the input 2D image on display panel 450.

For example, when display panel 450 is an n-view stereoscopic display panel, the input 2D data Dᵢₙₚᵤₜ are converted according to the following equation into 2D image data D_{3D} that can be displayed on display panel 450 without distortion.
D_{3D}=Dᵢₙₚᵤₜ×\sqrt{n} [Equation 1]

Namely, when display panel 450 is a 9-view display panel with a resolution of 3840×2400, the input 2D image is enlarged three-fold in each of the horizontal and vertical directions, so it can be displayed on display panel 450 without a barrier or lens effect.

In this way, display panel 450 displays a 3D image as received from image discriminator 410, or a converted 2D image received from image signal converter 430 without distortion.

FIG. 8 shows an example in which 2D and 3D images are displayed on display panel 450 according to the third embodiment of the present invention. In FIG. 8, the 2D image (a) shows the objects converted by image signal converter 430, and the 3D image (b) shows the objects displayed as input data without conversion.

By this conversion operation of image signal converter 430 for the conversion of the data resolution, display device 400 can display input image data on display panel 450 without distortion irrespective of whether the input image data represent a 2D image or a 3D image. In addition, display device 400 can display both 2D and 3D images on the same screen by the conversion of the input image data.

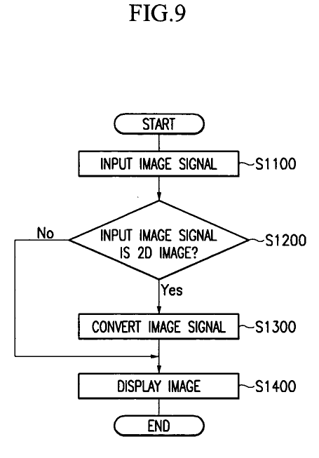

FIG. 9 is a flow chart of a display method for display device 400 according to the third embodiment of the present invention. First, an image signal to be displayed is externally fed into display device 400, in step S1100. Image discriminator 410 determines whether the input image is a 2D image or a 3D image. If the input image is a 2D image, then image discriminator 410 outputs the input image to image signal converter 430 for image data conversion. If the input image is a 3D image, then image discriminator 410 outputs the input image to display panel 450 because there is no need for image data conversion, in step S1200. Image signal converter 430 converts the 2D image data received from image discriminator 410 so as to display them on display panel 450 without distortion, and outputs the converted 2D image data to display panel 450, in step S1300. Display panel 450 displays the input image data, in step S1400.

By this conversion operation of image signal converter 430, display device 400 can display the input image data on display panel 450 without distortion irrespective of whether the input image data represent a 2D image or a 3D image. Display device 400 can also display both 2D and 3D images on the same screen by the conversion of the input image data.

When the display panel is a 2D display panel as described in the third embodiment and the input image is a 3D image in step S1200, the input image is output to the image signal converter for image data conversion. On the other hand, when the display panel is a 2D display panel and the input image is a 2D image, the input image is output to the display panel without a need for image data conversion.

The following description is given as to a fourth embodiment of the present invention. The display device according to the fourth embodiment of the present invention is different from the display device according to the third embodiment in that it includes a display panel for displaying a 2D image. In the display device according to the fourth embodiment of the present invention, an image discriminator determines whether input image data represent a 3D image or a 2D image. If the input image data represent a 3D image, then the image discriminator informs an image signal converter that the input image data represent a 3D image. Upon receiving the 3D image from the image discriminator, the image signal converter converts the resolution of the input image data based on the resolution of the display panel so as to display the input 3D image on the 2D display panel.

For example, according to the fourth embodiment, when the input 3D image is an n-view stereoscopic image, the input 3D image data Dᵢₙₚᵤₜ are converted according to the following equation into 3D image data D_{2D} that can be displayed on the 2D display panel without distortion.

$${D}_{2 D} = \frac{{D}_{input}}{\sqrt{n}} \qquad [ Equation 2 ]$$

By this conversion operation of the image signal converter, the display device can display input image data on the display panel without distortion irrespective of whether the input image data represent a 2D image or a 3D image. In addition, the display device can display both 2D and 3D images on the same screen by the conversion of the input image data.

With the display device according to the fourth embodiment of the present invention, a 9-view 3D image with a resolution of 3840×2400 is reduced three-fold in each of the horizontal and vertical directions by the image signal converter, so it can be displayed on the 2D display panel without distortion.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

Therefore, according to the present invention, a 2D image as well as a 3D image can be displayed without distortion by way of a simple conversion of the resolution without the additional use of a device including a 3D display panel, or a complicated device or function.

Hence, the present invention is applicable to all 3D display devices using the barrier method or a lenticular lens in displaying a 2D image, and allows the use of a 3D display panel in a display device using a display panel for displaying a 2D image, such as a PC, mobile phone, PDA, etc. Therefore, the present invention enhances the usefulness of 3D display devices.

The 3D display panel of which the basic resolution is high can present a 2D image with an enhanced resolution as well as a 3D image of a high resolution.

1. A stereoscopic display device for displaying an input image on a display panel, the stereoscopic display device comprising:
an image discriminator for determining whether the input image is a two-dimensional image or a three-dimensional image; and
a resolution converter for converting a resolution of the display panel based on a determination result of the image discriminator.

2. The stereoscopic display device as claimed in claim 1, wherein the input image is displayed by an execution of a specific program.

3. The stereoscopic display device as claimed in claim 2, further comprising a signal detector for detecting a start signal, an end signal, or an inactivation signal of the specific program, and outputting the detected signal to the image discriminator.

4. The stereoscopic display device as claimed in claim 3, wherein upon the start signal of the program being detected by the signal detector, the image discriminator determines whether the program is a two-dimensional program or a three-dimensional program.

5. The stereoscopic display device as claimed in claim 3, wherein upon the end signal or the inactivation signal of the program being detected by the signal detector, the image discriminator determines whether an image to be displayed on the display panel is a two-dimensional image or a three-dimensional image.

6. A stereoscopic display method comprising:
(a) determining whether an input image is a two-dimensional image or a three-dimensional image;
(b) converting a resolution of a display panel based on a determination result of the determining whether an input image is a two-dimensional image or a three-dimensional image; and
(c) displaying the input image on the display panel.

7. The stereoscopic display method as claimed in claim 6, wherein the input image is displayed by an execution of a specific program.

8. The stereoscopic display method as claimed in claim 7, further comprising:
(d) detecting a start signal, an end signal, or an inactivation signal of the specific program before the determining whether an input image is a two-dimensional image or a three-dimensional image.

9. The stereoscopic display method as claimed in claim 8, wherein the determining whether an input image is a two-dimensional image or a three-dimensional image is performed in response to the signal detected in the detecting a start signal, an end signal, or an inactivation signal of the specific program before the determining whether an input image is a two-dimensional image or a three-dimensional image.

10. A stereoscopic display device for displaying an input image on a display panel, the stereoscopic display device comprising:
an image discriminator for determining whether the input image is a two-dimensional image or a three-dimensional image; and
an image signal converter for converting a resolution of the input image according to a resolution of the display panel based on the determination result of the image discriminator.

11. The stereoscopic display device as claimed in claim 10, wherein the display panel has a resolution for displaying a three-dimensional image.

12. The stereoscopic display device as claimed in claim 11, wherein when the input image is a two-dimensional image, the image signal converter converts the resolution of the input image based on the resolution of the display panel.

13. The stereoscopic display device as claimed in claim 10, wherein the display panel has a resolution for displaying a two-dimensional image.

14. The stereoscopic display device as claimed in claim 13, wherein when the input image is a three-dimensional image, the image signal converter converts the resolution of the input image based on the resolution of the display panel.

15. A stereoscopic display method comprising:
(a) determining whether an input image is a two-dimensional image or a three-dimensional image; and
(b) converting a resolution of the input image based on the resolution of a display panel according to a determination result of determining whether an input image is a two-dimensional image or a three-dimensional image.

16. An executable program on a recording medium for a stereoscopic display method for displaying an image on a display panel by an execution of instructions for a specific program, the executable program comprising:
(a) detecting a start signal, an end signal, or an inactivation signal of the specific program;
(b) with the start signal detected by the detecting a start signal, an end signal, or an inactivation signal of the specific program, determining whether the specific program is a two-dimensional program or a three-dimensional program;
(c) with the end signal or the inactivation signal detected by the detecting a start signal, an end signal, or an inactivation signal of the specific program, determining whether the image to be displayed on the display panel is a two-dimensional image or a three-dimensional image;
(d) determining a resolution of the display panel according to the determination result of the determining whether the specific program is a two-dimensional program or a three-dimensional program or the determining whether the image to be displayed on the display panel is a two-dimensional image or a three-dimensional image; and
(e) converting a resolution of the display panel according to the determination result of determining a resolution of the display panel according to a determination result of the determining whether the specific program is a two-dimensional program or a three-dimensional program or determining whether the image to be displayed on the display panel is a two-dimensional image or a three-dimensional image.

17. An executable program on a recording medium for a stereoscopic display method, the executable program having the functions of:
(a) determining whether an input image is a two-dimensional image or a three-dimensional image; and
(b) converting a resolution of the input image based on the resolution of a display panel according to a determination result of the determining whether an input image is a two-dimensional image or a three-dimensional image.
